(19) United States
(12) Patent Application Publication
(10) Pub. No.: US 2002/0069296 A1
(43) Pub. Date: Jun. 6, 2002

(54) Internet content reformatting apparatus and method

(76) Inventors: Bernie Aua, Wesminster, CA (US); Jarrad DeMaria, Lake Forest, CA (US); Kia Shirali, Orange, CA (US)

Correspondence Address: CISLO & THOMAS, LLP, 233 WILSHIRE BLVD, SUITE 900, SANTA MONICA, CA, 90401-1211, US

(21) Appl. No.: 09/732,220

(22) Filed: Dec. 6, 2000

(51) Int. Cl. G06F 15/16

(52) U.S. Cl. 709/246; 709/218

(57) ABSTRACT

Because of their nature, handheld computing/electronic devices with access to the Internet can experience limited access to content available on the Internet. For example, web sites may be inaccessible or the devices' view of a web page may be restricted. Herein is described a system that reduces these limitations by acting as a proxy/intermediary server between the handheld device and the Internet. When such a device makes a request for information from the Internet, that request goes through the system. The system retrieves the content from the Internet, transforms, reformats, and translates the content into a more usable format, and then returns the transformed content to the device. The result is the device has access to more Internet sites and is also able to view Internet content that it otherwise would not be able to see.

### BACKGROUND OF THE INVENTION

1. Field of the Invention

This invention relates to devices and methods that include software for accessing information from the Internet and providing the accessed information to an end user. The invention has particular applicability to handheld electronic/computing devices capable of Internet access.

2. Description of the Related Art

Internet content has been designed primarily for use and viewing by way of a desktop personal computer (the PC). Given the widespread popularity and use of the Internet along with evolving computer technology, handheld electronic and computing devices have emerged that are capable of Internet access. However, due to the small design of these units as well as the type of Internet access they utilize (such as wireless access), common Internet content such as web pages that were designed for a PC may not be fully viewed on these small devices and in some cases may not be viewed at all, essentially creating a barrier between these devices and the Internet.

As a result, a new collection of Internet content must be developed that caters better to these types of devices. As a consequence, this new content will be fragmented to the extent that some content will work only with specific devices (i.e. content developed for a PDA as opposed to a cellular phone).

Hence, a good portion of current web content and web content that will be developed in the future will be unavailable to these small devices. In a time when information and the Internet has proven to be as valuable as ever in the conduct of all degrees of business, having access to as much information as possible can be seen as a tool for empowerment, growth, development, and advancement.

What is needed, therefore, is a method or apparatus that can take web content in various forms and transform it into an appropriate format that is suited for viewing with these handbeld devices.

### SUMMARY OF THE INVENTION

In a preferred embodiment of the invention, a computer system is provided comprising of a proxy/intermediary server connected to the Internet. The proxy/intermediary server is able to access other Internet servers through its Internet connection. It is directed by data received from the handheld electronic/computing devices. It retrieves data from the Internet servers thus accessed, then transforms, reformats, and translates the data into an appropriate form. It delivers the transformed data to the handheld device.

### OBJECTS OF THE INVENTION

It is an object of the present invention to provide a seamless connection between a remote electronic device and a global communications network, the electronic device having reduced size and/or power display devices.

A further object of the present invention is to provide full hyperlink capabilities for the remote electronic device and to provide as complete a representation of the URL information as possible given the limited screen size or power capabilities.

A further object of this invention is to provide Internet content in a form consistent with the display devices of the remote electronic operator, including parsing columns within the HTML web pages.

A further object of the present invention is to provide task-oriented representations of the HTML web page content.

These and other objects and advantages of the present invention will be apparent from a review of the following specification and accompanying drawings.

### BRIEF DESCRIPTION OF THE DRAWINGS

FIG. 1 is a flow chart showing the steps of the method of one embodiment of the present invention.

FIG. 2 is a flow chart showing the steps in further detail of the method of one embodiment of the present invention.

FIG. 3 is a diagram showing the communication links between the several elements of one or more embodiments of the present invention.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

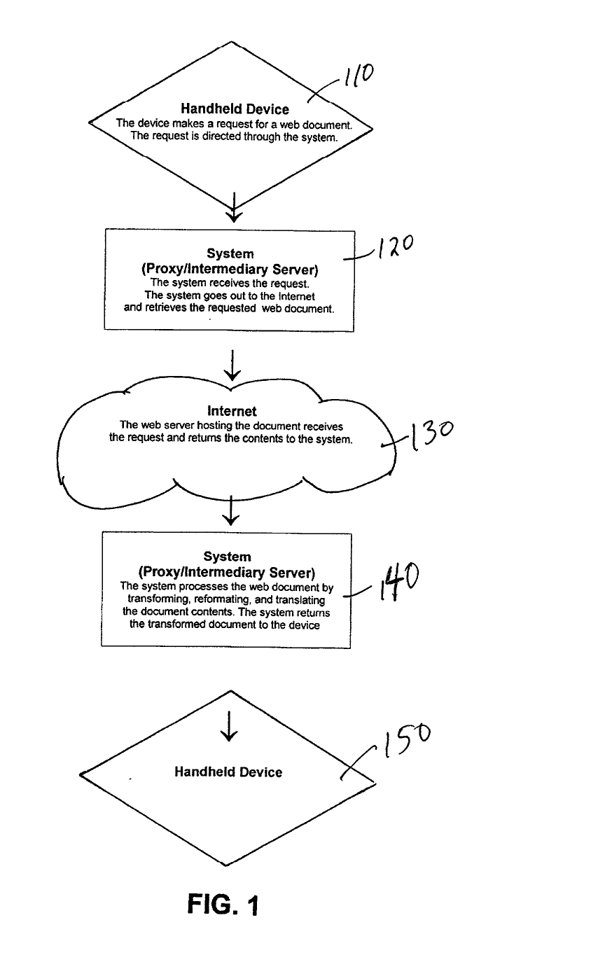

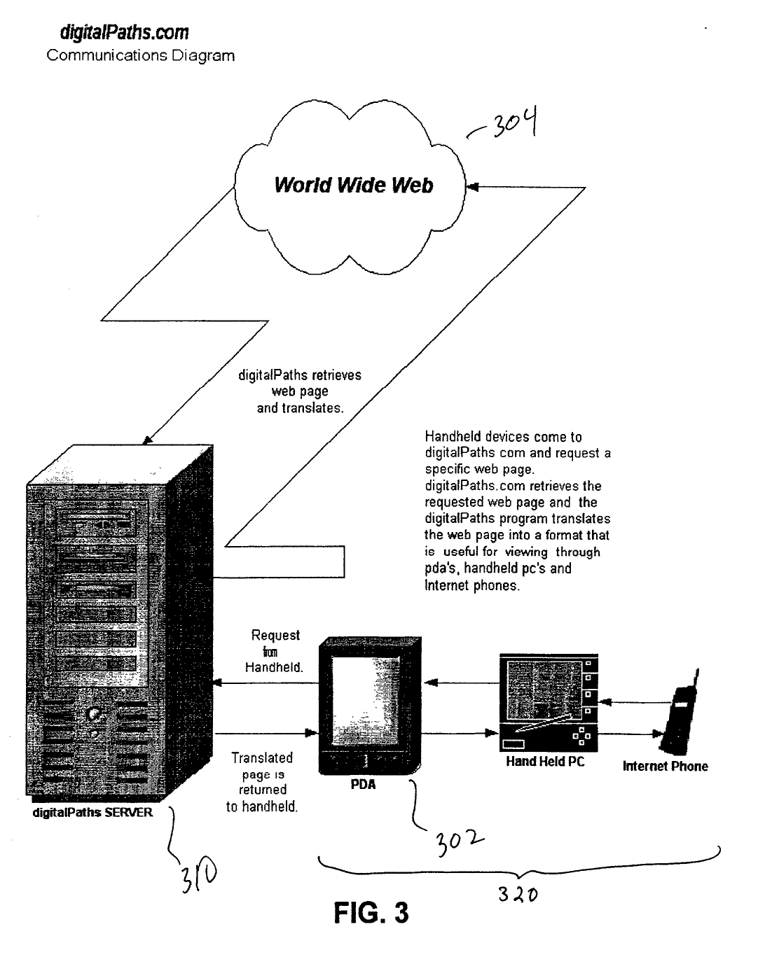

The user of a handheld device such as a PDA (Personal Digital Assistant) (FIGS. 1, 3) connects to the Internet 304 using his/her ISP (Internet Service Provider) and runs his or her browser or other comparable application that initiates Internet access. Within the application, the user brings up a form that is used to request the contents of a specific web page on the Internet. This form is accessed through a specific URL located on the proxy/intermediary server 310, or it is a form that resides on the device itself. The user enters the location or URL of the desired web page on the form and using the form submits a request for the web page 110 (FIG. 1).

The request is directed to the proxy/intermediary server 310 which receives the request and directs it to a CGI (common gateway interface) program that resides on the server. The proxy/intermediary server 310 may be a single server system or a multiple server system comprised of a cluster or group of servers working in parallel or in association with each other. A cluster or parallel configuration may be employed in the event the number of requests that must be processed by the proxy/intermediary system and the CGI program is more than a single server system can process in a timely manner.

The CGI program is a software application that analyzes the request and determines the type of device making the request 120. The CGI program goes out onto the Internet 304 and retrieves the contents of the web page (as specified in the request) from the web server hosting the page 130. The program then begins to execute a series of routines that examine the markup language (i.e. HTML) of the web page it retrieved. Based upon the type of device that made the request, the markup language is either transformed and reformatted into the same markup language, or it is converted and translated into a different markup language that is appropriate for the device. Any links to other web pages that may appear in the retrieved document are reconfigured in such a manner that if the user requests a document associated with a specific link, the request is made through the proxy/intermediary server 310. The link is configured such that 1) it points to the proxy/intermediary server 310 rather than directly to the web server where it is actually located, and 2) it tells the CGI application what web document is being requested 140.

The result is a new web document appropriate for the requesting device 320. The new document is then delivered or returned 150 to the device 320 by the proxy/intermediary server 310. The user is able to access other web documents by either entering a new location on the previously referenced form or by selecting any links that appear on the web document delivered by the proxy/intermediary server 310.

More specifically, the CGI program and series of routines include the steps of interpreting the contents of the web page, identifying the discrete columns within the web page from the HTML code, parsing according to columns within the web page, parsing text within each column of the web page according to the requirements of the screen or display device in the remote unit, and formatting such text portions of the columns parsed from the web page into a format acceptable to the remote unit. Further routines comprise identifying hyperlink information within the identified text of the columns and presenting them in reformatted configuration so that requests made by the operator of the remote unit 320 will return information to the proxy/intermediate server 310 which will in turn interpret the request, perform the previous requested operation, and repeat the above-mentioned steps and routines. To the operator of the remote unit 320, this series of routines will appear seamlessly to guide the operator through the Internet content through the hyperlink to the newly-requested URL location where the above steps and routines are repeated. If, instead, the remote unit requests a scrolling operation through the contents of the present web page, that is facilitated by repeating the above series of steps and routines on a different or new portion of the web page column or columns, according to the request to scroll up, down, left, or right, for example.

Another embodiment contemplated according to this invention involves parsing the columns of the web pages as described above according to the display devices in cellular telephones or the like. Parsing columns according to the needs of the display devices of cellular telephones requires more than mere reformatting, but rather may require translating the HTML content into a different mark-up language, such as HDML (handheld device markup language). According to this embodiment, the content of the web page will be transformed into what are more commonly called “choice” cards or “data” cards as used in the HDML language. Thus, according to the embodiment of the invention, an additional series of routines are required to further parse the HTML content. Further additional series of routines will translate the parsed HTML content into such choice cards and data cards for display on the small-display devices contained in the cellular telephone units or other such remote devices.

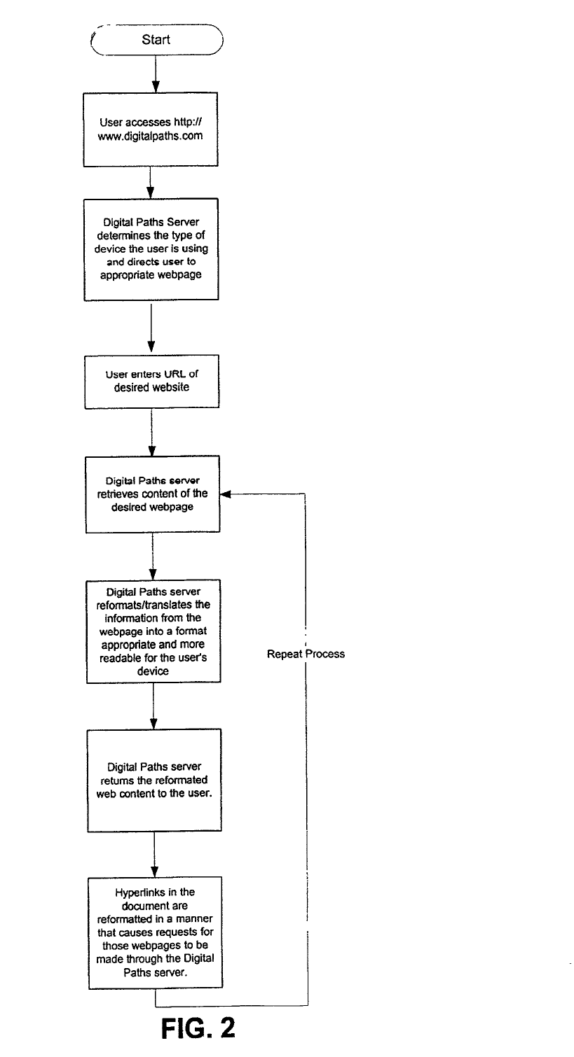

One embodiment of the present invention is set forth in logic flow form 200 in FIG. 2.

More specifically, the application is an implementation of a CGI script. CGI is also known as Common Gateway Interface. The script is written in the PERL scripting language. However, the application may also be written in another suitable language, such as Java or C/C++. Accordingly, the following steps are contemplated as an embodiment according to the present invention:

The user of the device initiates a request for a web document through the Digital Paths server. The document must be a standard web (HTML) document. The request either comes through a form that was submitted or a link that was selected.

The Digital Paths server 310 attempts to retrieve the requested web page. If an error occurred while trying to retrieve the document, the user is notified. If the document retrieval was successful, the document is loaded into the computer server's memory and we begin to execute steps that will convert the document into another form. The exact steps we execute will vary depending on the type of device that made the request, but they generally the flow as outlined here:

We assign configuration variables certain values depending on the device. These variables will dictate what steps are to be executed.

The following set of steps (1-16) is what occurs when an HTML document is reformatted into another HTML document:

1. Remove any type of scripting language from the document such as Javascript or VBScript.

2. Prepare the page so that further steps can be properly executed.

a. Remove “<” and “>” characters from within ALT and VALUE designations.

b. Make sure attribute values are enclosed in double quotes (”).

c. Remove white space between attribute value designations.

d. Remove comments.

3. Start removing various types of HTML tags based upon how the configuration variables were previously set. In some cases the tag is completely removed, in other cases the tag is replaced by another tag.

4. Start removing various types of HTML tag attributes. Again this is based on how the configuration variables were set.

5. Process image tags again depending on how the configuration variables were set. If the variable were set to indicate removal of the image, we remove all images and replace them with their corresponding ALT attribute text designation. In the case where an image contains embedded hypertext links, we convert the links into a standard text link.

6. Remove any type of link that is not a hypertext link (i.e. ftp, gopher, telnet links).

7. Process any frame designations that may exist. Depending on the configuration setting, the frame tags may be replaced with links to each frame's content.

8. Process all the hypertext links by fully qualifying the link. Then we prepend the link with a reference to the Digital Paths device file so that when link requests to go through the Digital Paths server, the appropriate device file is invoked for proper processing.

9. Based upon the configuration setting, convert any existing META refresh links into a regular hypertext link.

10. Process form tags. Forms are converted such that when a form is submitted by the user, it is submitted to the Digital Paths server along with all appropriate field values. The Digital Paths server then submits the form to the designated web site.

11. Depending on configuration settings, reduce the document size by removing new lines and carriage returns and we convert STRONG and EM tags to B and I tags respectively.

12. Clean up the document.

13. “Trim the fat” by removing unnecessary data such as extra white space, blank lines, META tags. No break spaces are converted to plain spaces. Horizontal rules are simplified.

14. Depending on the device, clip the size of the page according to what the user specified as the page size.

15. Insert a BASE tag with a reference to the Digital Paths server. This causes all document requests (link, forms) to go through the Digital Paths server.

16. Insert device-specific HTML tags into the document, which can be a number of things.

a. For Palm VII's, insert the appropriate META tags and a link to view the next page if the document they requested is larger than the page limit that was set by the user.

b. Add a link to the Digital Paths start page.

c. Font size may be reduced.

The next set of steps (1-8) applies to taking an HTML document and converting it to an HDML document. This is to primarily service Internet Phones that can only view HDML documents:

1. Remove any type of scripting language from the document such as Javascript or VBScript (same as #1 above).

2. Prepare the page so that further steps can be properly executed (same as #2 above).

3. Insert code into the document to mark paragraph and line break tags and to mark hypertext links.

4. Strip all HTML tags from the document. This essentially removes all images and HTML formatting.

5. Paragraph and line breaks that were marked are now converted to their HDML equivalent.

6. Links that were marked are converted back to HTML, then they are fully qualified, and then they are converted to their HDML equivalent.

7. The document is truncated due to size limitations with Internet phones.

8. Insert an HDML tag containing a variable that is assigned an URL value. This variable used in conjunction with the link designations in the document so that link requests through the Digital Paths server and the appropriate device file is invoked.

9. Insert a link to the Digital Paths start page.

10. Insert a link to view the next page if the document size was greater than the limit referenced in #6.

This process removes forms from the document. The invention further contemplates additional steps to maintain and convert forms into an HDML equivalent.

Other embodiments are also contemplated, for example, a similar system for converting a WML (White Meta language) document into an HTML document, or for utilizing this system to provide Internal access to network-capable appliances and the like.

While the present invention has been described with regards to particular embodiments, it is recognized that additional variations of the present invention may be devised without departing from the inventive concept.

What is claimed is:

1. A method for reformatting a document formatted in a markup language so that the document may be made more compatible, the steps comprising:
providing a web server;
providing a web page, said web page requested by said web server;
removing first codes from said web page, said first codes incompatible with a desired format to provide a translated web page; and
transmitting said translated web page; whereby
said web page may be made more compatible with a device that better receives electronic information in said desired format.

2. A method for reformatting a document formatted in a markup language made more compatible as set forth in claim 1, the steps further comprising:
adding second codes to said translated web page to provide a second translated web page, said second codes compatible with said desired format.

3. A method for reformatting a document formatted in a markup language made more compatible as set forth in claim 2, wherein the step of adding second codes further comprises:
adding said second codes in place of said first codes; whereby
said second translated web page better conforms with said desired format.

4. A method for reformatting a document formatted in a markup language made more compatible as set forth in claim 1, wherein the step of removing first codes comprises removing codes selected from the group consisting of:
scripting language;
“<” and “>” characters from within ALT and VALUE designations;
white space between attribute value designations;
comments;
HTML tags;
HTML tag attributes;
images;
ftp links;
gopher links;
telnet links; and
non-HTML links.

5. A method for reformatting a document formatted in a markup language made more compatible as set forth in claim 3, wherein the step of adding said second codes in place of said first codes comprises code swapping events selected from the group consisting of:
processing a hypertext link by fully qualifying said link and prepending said link with an address reference to a web server device file so that when link requests to go through said web server, an appropriate device file is invoked for proper processing;
converting any existing META refresh links into a regular hypertext link; and
converting a form such that when said form is submitted by a user, it is submitted to said web server along with all appropriate field values, said web server then submitting said form to a designated web site.

6. A method for reformatting a document formatted in a markup language so that the document may be made more compatible as set forth in claim 2, wherein the step of adding second codes to said translated web page comprises adding second codes selected from the group consisting of:
BASE tags with a reference to said web server, whereby all document requests including link requests and form requests go through said web server;
device-specific HTML tags;
META codes;
links to view a next page if a requested document requested is larger than a desired page size;
links to a start page of said web server.

7. A system for providing Internet access to wireless communication devices, comprising:
a server, said server in communication with the Internet;
a web page, said web page present on said server, said web page being available and accessible to a wireless communications network; and
said web page enabling translation of web pages on the Internet to a format acceptable to wireless communications devices; whereby
wireless communication devices may access the Internet through said web page via said wireless communications network and receive translated web pages in a more compatible format.

8. A system for providing Internet access to wireless communication devices as set forth in claim 7, further comprising:
said web page transmitting translated web pages to said wireless communications network.
